(19) United States
(12) Patent Application Publication
(10) Pub. No.: US 2014/0171177 A1
(43) Pub. Date: Jun. 19, 2014

(54) CASINO GAME WITH AUTOMATIC MID-GAME WAGER SUPPLEMENT UPON TRIGGER EVENT

(71) Applicant: Gemini Digital Development, Inc., Las Vegas, NV (US)

(72) Inventors: Alfred Thomas, Las Vegas, NV (US); James P. Jackson, Henderson, NV (US); Rohan E. Mascarenhas, Bangalor (IN)

(73) Assignee: Gemini Digital Development, Inc., Las Vegas, NV (US)

(21) Appl. No.: 14/107,290

(22) Filed: Dec. 16, 2013

Related U.S. Application Data
(60) Provisional application No. 61/738,304, filed on Dec. 17, 2012.

(51) Int. Cl. G07F 17/34

(52) U.S. Cl. CPC G07F 17/34
USPC 463/20; 463/25

(57) ABSTRACT

The player places a bet in a gaming machine prior to initiating the game of chance, such as a reel-type game, wherein an award amount for a winning outcome of the game is based on the amount bet. The player initiates the game, such as starting the spinning of reels, which locks out further bets by the player. The reels stop in sequence and, if prior to the last reel stopping, a trigger event occurs, such as a certain number of wild symbols occurring, the game is immediately halted prior to the game being completed. The machine then automatically places a supplemental bet without player intervention, where the supplemental bet is not deducted from the player's bank of credits. The game then continues on until completion. The award to the player for any winning combinations is based on the player's bet and the supplemental bet. Other variations are described.

### CROSS-REFERENCE TO RELATED APPLICATIONS

This application claims priority to U.S. provisional application Ser. No. 61/738,304, filed on Dec. 17, 2012, by the present inventors.

### FIELD OF THE INVENTION

This invention relates to gaming devices, such as slot machines, and, in particular, to a game feature that supplements the player's bet upon a trigger event occurring.

### BACKGROUND

Conventional reel-type video slot machines accept the player's bet of credits, randomly stop the spinning of virtual reels to display a final array of symbols, then grant an award to a player based on the occurrence of winning symbol combinations across paylines and based on the player's initial bet per payline. The award for any particular winning symbol combination is usually a multiple of the bet and programmed into a paytable. The player's bet is variable between a minimum and maximum allowable bet. The activated paylines may be automatic or may be selected by the player. Once the player initiates the spinning of the virtual reels, there can be more betting. This leads to the player regretting she has not bet more when a winning symbol combination occurs.

### SUMMARY

In one embodiment, the player bets a number of credits for a single slot machine game involving virtual reels. In one example, there are five reels and a maximum of four displayed symbols per reel, forming a 4×5 matrix of symbols. There may be 50 different paylines across the five reels. The player may bet from 1 credit per payline to 5 credits per payline for the maximum bet. In the scenario below, the player bets the minimum of one credit per payline for a total of 50 credits. The player then presses the “spin reels” button to initiate the reels spinning.

The reels pseudo-randomly stop in sequence from left to right to create tension. If there are two special wild symbols revealed by the first two reels, the player is likely to win, assuming three or more of the same symbol across a payline is a winning combination. Once this trigger event occurs (i.e., the display of the two special wild symbols), the game is temporarily halted while the reels 3-5 are shown still spinning. The player is treated to an animation, or other secondary action, where a supplemental bet is automatically made and displayed in a special credit meter. The supplemental bet may be the same as the player's initial bet or may be another amount. The supplemental bet is not taken out of the player's bank of credits, so there is no drawback to the player.

Any other mid-game trigger event is contemplated. However, basing the trigger event on the likelihood of the player obtaining a winning symbol combination accomplishes the desirable result of preventing the player from regretting that she did not bet enough.

Now the player becomes more excited because the possible award has just doubled. In other embodiments, the supplemental bet can be more or less than the player's bet.

The final three reels are then allowed to randomly stop to display the final array of symbols.

The player is first paid an award, determined by a paytable, based on the player's initial bet and the winning combinations of symbols across any of the activated paylines, which is conventional. The player is then paid a supplemental award based on the amount of the supplemental bet and the winning combinations. In one embodiment, the supplemental bet is applied to all the winning combinations along any of the activated paylines in the array. In another embodiment, the supplemental bet is applied to only winning combinations across the payline(s) that includes the special wild symbols that caused the trigger event.

Thus, the total award is typically about doubled due to the supplemental bet. In other embodiments, the total award may be greater or less than doubled.

The mathematics of the game (payout percentage, paytable, win frequency, etc.) takes into account the windfall by the player when the trigger event occurs, so the gaming machine does not lose profitability as a result of the feature. However, the feature will cause the player to play longer and attract more players to the machine due to the added excitement of the feature.

Instead of the trigger event being a special wild symbol on the first two reels, the trigger event may be any combination of symbols that guarantees a win for the player prior to all the reels stopping or creates a high probability of the player winning. In one embodiment, the trigger event may be the occurrence of two or more wild symbols on any of the first four reels to stop spinning. Alternatively, the trigger event may be any random event, such as a mystery event. For networked games, the trigger event may occur at any time and apply simultaneously to a bank of related gaming machines programmed with the feature.

If the gaming machine offers a bonus game for a particular outcome of the main game, the supplemental bet may carry over to the bonus game to enhance any win.

Other variations are described.

The game applies equally to on-line games and games played on portable devices, as well as stand-alone electronic gaming machines in a casino. The feature may also be applied to non-video reel-type games and to other than reel-type games.

Additional variations of the games are described herein.

### BRIEF DESCRIPTION OF THE DRAWINGS

FIG. 1 illustrates a gaming machine that displays a reel-type game on a video screen and is programmed to perform the inventive feature.

FIG. 2 is a block diagram of key components in the gaming machine of FIG. 1 and illustrates a network connected to linked gaming machines.

FIG. 3 is a flowchart identifying various steps performed in accordance with an embodiment of the invention.

FIG. 4 is a simulated screen shot prior to five reels being spun, showing the player's bet of 50 credits for 1 credit per payline.

FIG. 5 illustrates that the first two reels stopped to display two special wild symbols, guaranteeing a win (or making a win very likely) and providing the trigger event for the feature.

FIG. 6 illustrates that a supplemental bet is being made by the machine, equal to the player's bet, as a result of the trigger event while the last three reels continue to spin.

FIG. 7 illustrates the final symbol array, highlighting a winning payline and granting the player 100 credits for the winning combination based on the player's bet and another 100 credits for the winning combination based on the supplemental bet. The player wins any additional awards for winning symbol combinations on other activated paylines.

### DETAILED DESCRIPTION

Although the invention can typically be implemented by installing a software program in most types of modern video gaming machines, one particular gaming machine platform will be described in detail.

FIG. 1 illustrates a video gaming machine 10 that incorporates the present invention. The machine 10 includes a bottom display 12 that may be a thin film transistor (TFT) display, a liquid crystal display (LCD), a cathode ray tube (CRT), or any other type of display. The display 12 may also be a transparent area revealing physical motor-driven reels. In the example shown, the main game shown on the display 12 is the random selection of a 3×5 array of symbols, where an award is granted based on the combination of symbols across any number of paylines, such as the payline 13. The main game can be any game, such as a 4 row×5 column array of symbols, a 3 row×3 column array of symbols, or any other size or shape array, a video card game, a guessing game with hidden symbols, or other game.

A top display 14 is a video screen, which may be identical to the display 12, that displays a bonus game, or the paytable, or the game's theme, or any other information. The display 14 may instead be backlit painted glass.

A coin slot 16 accepts coins or tokens in one or more denominations to generate credits within the machine 10 for playing games. An input slot 18 accepts various denominations of banknotes or machine-readable tickets, and may output printed tickets for use in cashless gaming. A coin tray 20 receives coins or tokens from a hopper upon a win or upon the player cashing out. Player control buttons 22 include any buttons needed for the play of the particular game or games offered by machine 10 including, for example, a bet button, a spin reels button, a cash-out button, and any other suitable button. Buttons 22 may be replaced by a touch screen with virtual buttons.

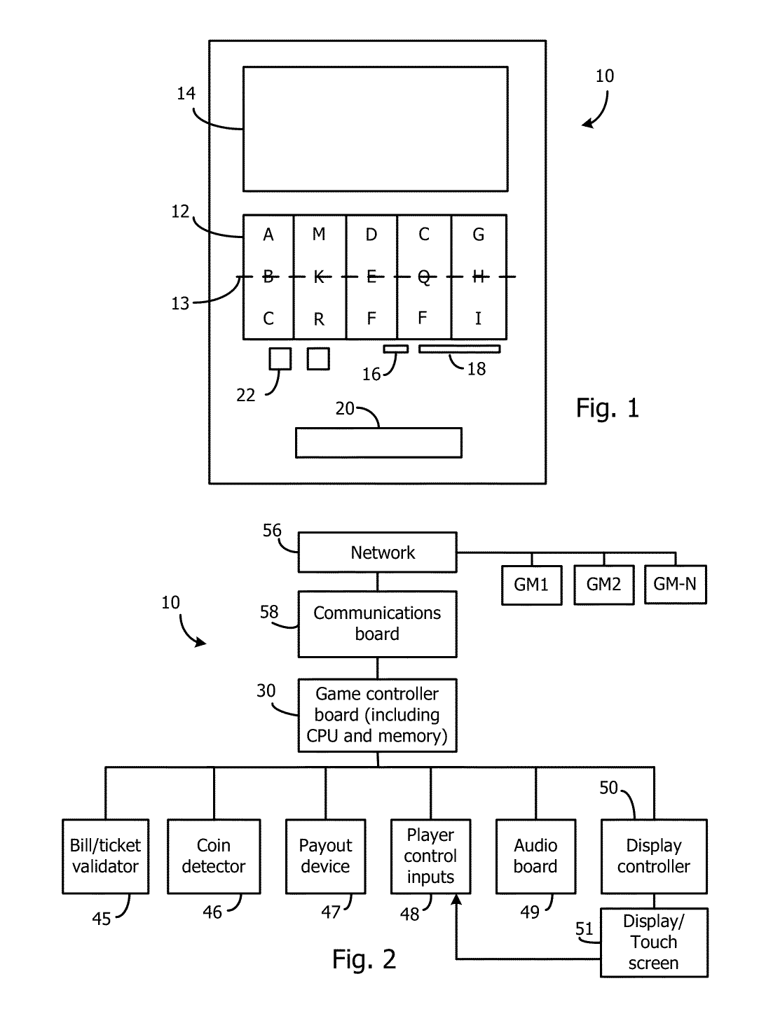

FIG. 2 illustrates basic circuit blocks in the machine 10 of FIG. 1. A game controller board 30 includes a processor (CPU) that runs the gaming program (including the secondary game) stored in a program ROM, such as a CD. The program ROM may include a pseudo-random number generator program for selecting symbols and for making other random selections. At least the active portion of the program is stored in a RAM on the board 30 for access by the processor. A pay table ROM on the board 30 detects the outcome of the game and identifies awards to be paid to the player. A bill/ticket validator 45 and coin detector 46 add credits for playing games. A payout device 47 pays out an award to the player in the form of coins or a printed ticket at the end of a game or upon the player cashing out. Player control inputs 48 receive push-button or touch-screen inputs for playing the game. An audio board 49 sends signals to the speakers. A display controller 50 receives commands from the processor and generates signals for the various displays 51. The touch screen portion of the displays 51 provides player selection signals to the processor.

The game controller board 30 transmits and receives signals to and from a network 56 via a communications board 58. The network 56 includes servers and other devices that monitor the linked gaming machines 10 and GM1-GM-N and provide communications between the machines 10 and GM1-GM-N.

In the below scenario, it is assumed that the software program for playing the reel-type game having the inventive feature is installed in a standalone gaming machine. However, the program may be downloaded to any processing device using a display screen for playing the game. The credits bet may represent a monetary amount (such as for a casino game) or a non-monetary amount (such as where the game is played solely for amusement), and any award may represent a monetary amount or a non-monetary amount.

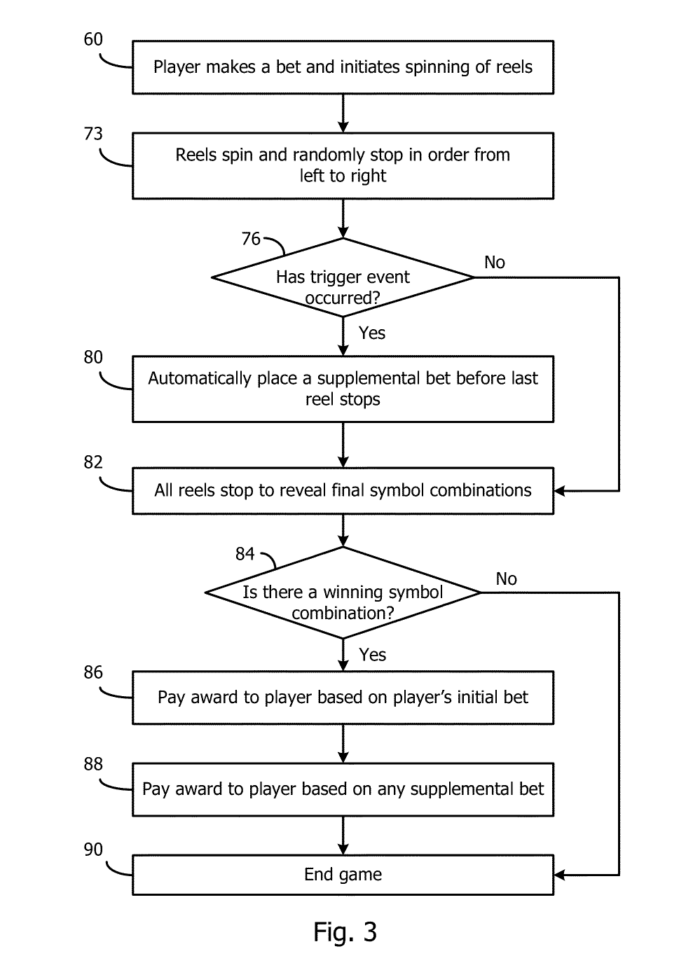

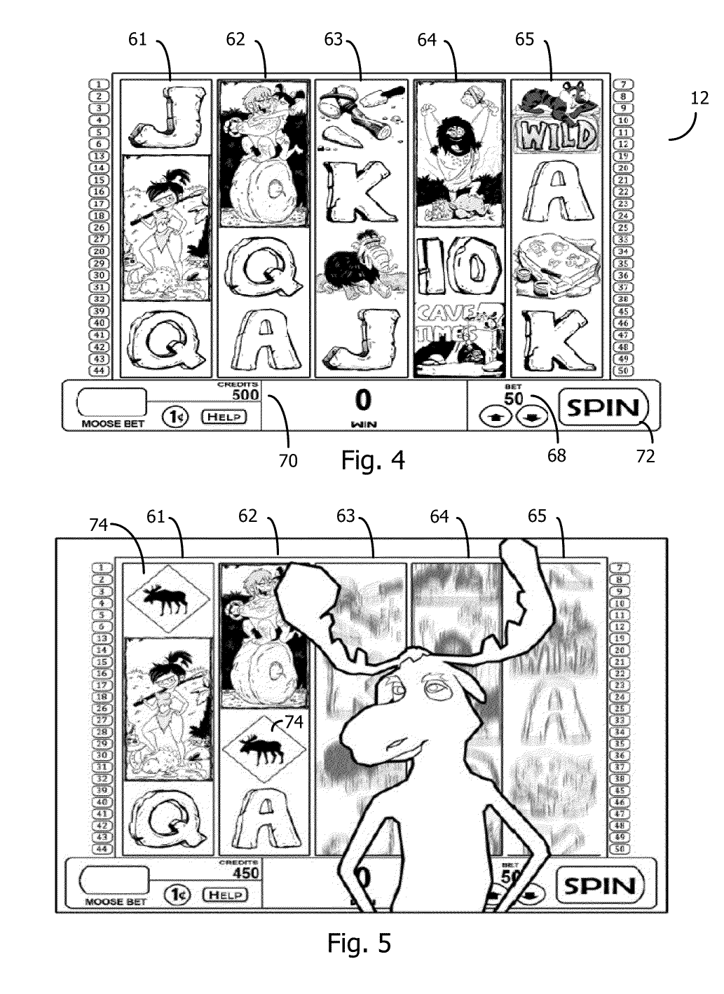

FIG. 3 is a flowchart identifying various steps performed in accordance with an embodiment of the invention, and FIGS. 4-7 are simulate screen shots for a game displaying five virtual reels, where each reel displays three or four symbols, depending on the size of the symbols.

In step 60 of FIG. 3, the player makes a bet and initiates spinning of the virtual reels.

FIG. 4 is a simulated screen shot prior to the five reels (61-65) being spun, showing the player's bet of 50 credits, for 1 credit per payline, displayed in a bet meter 68 area of the display 12. In the example, the minimum bet is 1 credit per payline, and all the paylines are activated. In other types of games, the player may selectively activate paylines. The display 12 is a touch screen, and the player may touch any of the payline numbers (1-50) on the edge of the reels to highlight each of the 50 paylines that can be activated.

The player may increase or decrease the bet by touching the up and down arrow icons below the bet meter 68. In one example, the maximum bet is 5 credits per payline, for a total maximum player bet of 250 credits for a single game. In the example, each credit is worth one cent.

The player's total credit bank is shown by the credit meter 70 area of the display 12.

The player then touches the SPIN icon 72 to lock in the bet and start spinning the reels 61-65 (step 73).

A pseudo-random number generator in the gaming machine, which may be a subroutine running on the game controller board 30, determines the stopping position of each of the five reels 61-65. A software routine animates the reels spinning and stops the reels in sequence starting from the left side (step 73).

FIG. 5 illustrates the screen after the first two reels 61/62 have stopped. A special wild symbol 74 has appeared on each the reels 61/62, meaning that the player will likely obtain at least three of the same symbol on a single payline. The two wild symbols 74 are not on the same payline, in the example. The trigger event for the inventive feature in this example is the display of the wild symbols 74 on the first two reels in any payline, whether or not the payline is the same. If the wild symbols 74 were on the same payline, the player would be guaranteed a win if three of the same symbol provided an award. In another embodiment, the trigger event may be two wild symbols 74 on the first three reels or the first four reels. In other embodiments, the trigger event for the feature may be another random event based on time, or based on the number of plays since the last trigger event, or based on whether the player is losing, etc. If the machine is part of a bank of linked machines, the trigger event may apply to all the linked machines at the same time. In another embodiment, the ability for the trigger event to even occur may be limited to a particular time period, and the players would be notified if the feature is activated to promote continued play of the machines.

In the example of FIGS. 4-7, meeting the trigger event criteria (wild symbols on reels 61 and 62) generally means that the player is very likely, or guaranteed, to win and, normally, the player would regret not having bet more (step 76). One purpose of the invention is to mitigate such a regret.

As the remaining three reels are still spinning, an animation occurs, in this case a moose, which highlights to the player that the machine is about to automatically place a supplemental bet on the outcome of the game. In the example, the supplemental bet will match the player's bet (to reward the player for making a high bet); however, the supplemental bet may be any amount and may even be a randomly chosen amount.

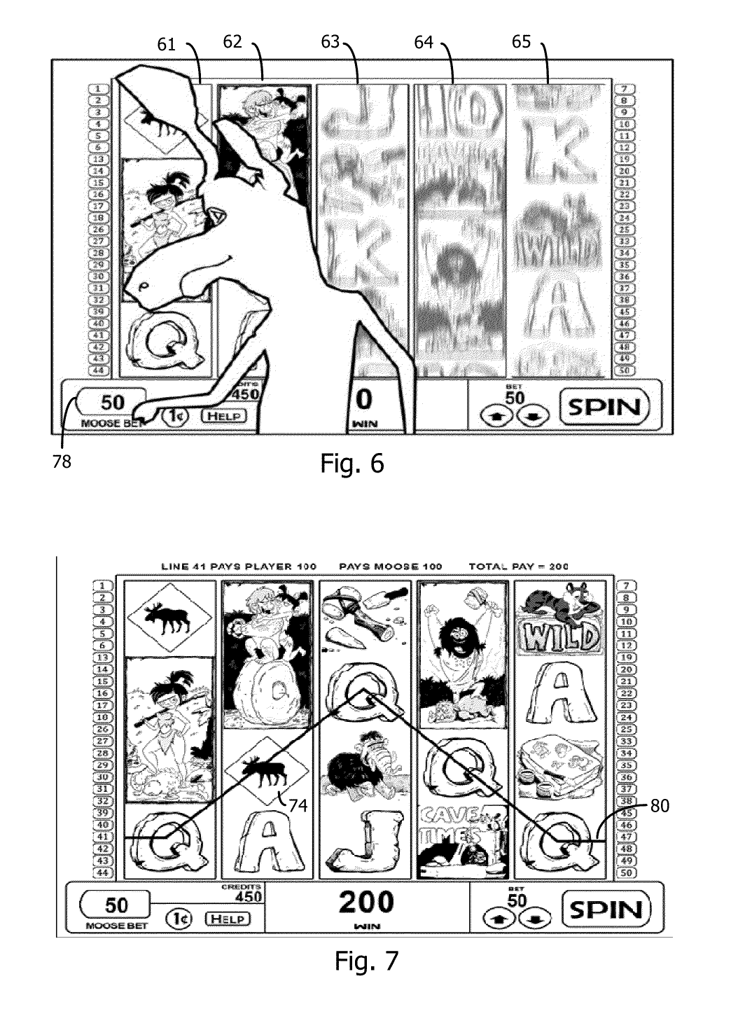

FIG. 6 illustrates the moose placing the supplemental bet by incrementing the supplemental bet meter 78 (step 80). The supplemental bet is not deducted from the player's bank of credits, so there can be no drawback to the player even if there is ultimately no winning combination of symbols. By the supplemental bet matching the player's bet, the player is incentivized to make higher bets; however, in other embodiments, the supplemental bet can be any amount. Any loss in revenue related to the feature is recouped by properly programming the mathematics of the game, such as the payout table, average win frequency, average payout percentage, average symbol occurrence frequency, etc.

After the supplemental bet is placed, the remaining reels 63, 64, 65 stop in sequence, as shown in FIG. 7 (step 82).

In another embodiment, an additional supplemental bet may be made upon the occurrence of additional trigger events, such as additional wild symbols 74 appearing on the reels.

FIG. 7 illustrates the final symbol array, highlighting a winning payline 80 and granting the player 100 credits for the winning combination based on the player's bet and another 100 credits for the winning combination based on the supplemental bet (steps 84, 86, 88). The total amount won is shown as 200 credits. The award is based on the paytable, and the supplemental bet is treated the same as a player bet for purposes of the award amount. In the example, the player obtained the equivalent of five Q symbols along the payline 80, with the benefit of the wild symbol 74. The player wins any additional awards for winning symbol combinations on other activated paylines, whether they include the wild symbols 74 or not.

In one embodiment, the supplemental bet is applied to all winning symbol combinations on any activated payline, whether or not the combinations included a wild symbol 74 that caused the trigger event. In another embodiment, the supplemental bet is applied to only winning symbols combinations that involve the wild symbols 74 that caused the trigger event.

The game then ends (step 90), and the player may bet on the next game.

Accordingly, various embodiments have been described where the machine automatically places a supplemental bet for the player mid-game when it appears likely, or definite, that the player will obtain at least one winning symbol combination so that the player will not regret betting more.

The supplemental bet feature is not limited to video reel-type games. The mid-game supplemental bet feature may be applied to motor-driven reel-type games, video card games (where the trigger event may be the first two dealt cards being the same rank, etc.), icon selection games, etc.

The term gaming machine or gaming device also applies to home computers, PDAs, cell phones, and other computer devices that carry out the game. The game may be carried out on a stand-alone machine, or on a machine connected to a server, or may be played on-line with a home computer connected to a server via the Internet, or may be played on a smartphone or tablet via the Internet, or by other processing devices. If all software to carry out the game is downloaded, then connection to the Internet may not be needed to carry out the game. For Internet games played on a personal processing device in which monetary amounts are awarded, the game outcome decisions are typically made by a secure remote server, and the processing device acts as the animation display and user interface.

The term “random” as used herein includes both pseudo-random and purely random.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A method performed by a gaming device, the gaming device including a processing system and a display, the method comprising:
detecting, by the processing system, a bet by a player prior to initiating a game of chance, wherein an award amount for a winning outcome of the game is based on an amount bet;
starting the game and displaying the game on the display;
locking out further bets by the player;
detecting a trigger event;
halting the game prior to the game being completed;
automatically placing a supplemental bet without player intervention;
continuing to carry out the game until it is completed;
detecting any winning outcome of the game; and
granting the player an award amount based on the player's bet and the supplement bet.

2. The method of claim 1 wherein the step of automatically placing a supplemental bet does not deduct any credits from any of the player's stored credits.

3. The method of claim 1 wherein the game displays rotating virtual reels which randomly stop in sequence, and wherein the trigger event comprises a plurality of special trigger symbols appearing on stopped reels prior to all reels stopping.

4. The method of claim 3 wherein the trigger event comprises wild symbols appearing on the first two reels to stop.

5. The method of claim 3 wherein the trigger event comprises a plurality of wild symbols appearing after a plurality of the reels, but not all reels, has stopped.

6. The method of claim 3 wherein, when the supplemental bet is being made, reels that have not yet stopped are shown still spinning.

7. The method of claim 1 wherein the step of automatically placing the supplemental bet only occurs when it is determined that the player's chances of obtaining a winning outcome have exceeded a certain threshold, including a guaranteed win.

8. The method of claim 7 wherein the step of automatically placing the supplemental bet only occurs when it is determined that the player is guaranteed a winning outcome.

9. The method of claim 1 wherein the supplemental bet equals the player's bet.

10. The method of claim 1 wherein the trigger event is related to a status of the game prior to the game being completed.

11. The method of claim 1 wherein the trigger event is unrelated to a status of the game as the game is being conducted.

12. The method of claim 1 wherein the trigger event occurs at a random time.

13. The method of claim 1 wherein the method is carried out by a gaming machine in a casino.

14. The method of claim 1 wherein the method is carried out by a processing device programmed to carry out the game.

15. The method of claim 1 wherein the method is carried out by the processing system while connected via the Internet to a server.

16. A gaming device comprising:
a display screen for displaying a game to a player; and
at least one computer programmed to carry out the following steps:
detecting a bet by a player prior to initiating a game of chance, wherein an award amount for a winning outcome of the game is based on an amount bet;
starting the game of chance and displaying the game on the display screen;
locking out further bets by the player after the game has started;
detecting a trigger event;
halting the game prior to the game being completed;
automatically placing a supplemental bet without player intervention;
continuing to carry out the game until it is completed;
detecting any winning outcome of the game; and
granting the player an award amount based on the player's bet and the supplement bet.

17. The device of claim 16 wherein the step of automatically placing a supplemental bet does not deduct any credits from any of the player's stored credits.

18. The device of claim 16 wherein the game displays rotating virtual reels which randomly stop in sequence, and wherein the trigger event comprises a plurality of special trigger symbols appearing on stopped reels prior to all reels stopping.

19. The device of claim 18 wherein the trigger event comprises a plurality of wild symbols appearing after a plurality of the reels, but not all reels, has stopped.

20. The device of claim 16 wherein the step of automatically placing the supplemental bet only occurs when it is determined that the player's chances of obtaining a winning outcome have exceeded a certain threshold.
